(19) United States
(12) Patent Application Publication
(10) Pub. No.: US 2026/0095370 A1
(43) Pub. Date: Apr. 2, 2026

(54) SYSTEMS AND METHODS FOR DETERMINING AND LOCATING NETWORK COMPONENT ERRORS IN A DISTRIBUTED NETWORK

(71) Applicant: BANK OF AMERICA CORPORATION, CHARLOTTE, NC (US)

(72) Inventors: John Andres Lozes, Wilmington, DE (US); Amer Ali, Jersey City, NJ (US); Aravind Singtalur, McKinney, TX (US); Mohammad Saleem Gaziani, Plano, TX (US); Andrea M. Weisberger, Jacksonville, FL (US); Aaron Gee, Palm Coast, FL (US); Tonya Kyra Miller, Charlotte, NC (US); Aisha Jenkins, Atlanta, GA (US); Asha Thekkumpurath, Frisco, TX (US); Manonmani Palanichamy, Fort Mill, SC (US); Naresh Kumar Petapalle, Greater London (GB)

(73) Assignee: BANK OF AMERICA CORPORATION, CHARLOTTE, NC (US)

(21) Appl. No.: 18/903,766

(22) Filed: Oct. 1, 2024

(51) Int. Cl. H04L 41/0677; H04L 41/16; H04L 41/22

(52) U.S. Cl. CPC H04L 41/0677; H04L 41/16; H04L 41/22

(57) ABSTRACT

Systems, computer program products, and methods are described herein for determining and locating network component errors in a distributed network. The present invention is configured to collect, from at least one source component, exception data at a pre-defined interval; group the exception data into a bucket(s) based on the at least one source component, the pre-defined interval, and an exception type; determine, based on the bucket(s) and by an artificial intelligence (AI) pattern module, an average exception count for the bucket(s) over the pre-defined interval; collect historical exception data associated with the bucket(s); compare, by the AI pattern module, the historical exception data associated with the bucket(s) and the average exception count for the bucket(s); and determine, based on the comparison, an outlier exception pattern for the bucket(s) for the pre-defined interval.

### FIELD OF THE INVENTION

The present invention embraces a system for determining and locating network component errors in a distributed network.

### BACKGROUND

In today's current technology environment, so many components perform so many tasks to keep applications, data centers, servers, and/or the like up and running, and running smoothly without interruption. However, it is extremely difficult for operators of these technical components, operators of these applications, data centers, servers, and/or the like, to be aware of each error or exception that occurs or whether any of these errors or exceptions are part of a broader pattern within the technical components. It is especially difficult to determine these broader patterns of exceptions when the exception patterns only occur once in a 28 day period, or only a handful of times within a month, especially when so much data is collected continuously, and the data is difficult to sift and analyze due to its size and extensiveness. Thus, and based on these technical problems, a system that can determine the exception counts of these technical environments must be efficient and accurate with determining when exceptions arise—in real time or near real time—and when the exceptions are likely to arise again. Thus, a system that can determine and locate network component errors in a distributed network efficiently, accurately, and dynamically is necessary to keep these technical environments and their downstream components and applications running smoothly and without interruption.

Applicant has identified a number of deficiencies and problems associated with determining and locating network component errors in a distributed network. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for determining and locating network component errors in a distributed network is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: collect, from at least one source component, exception data at a pre-defined interval; group the exception data into at least one bucket based on the at least one source component, the pre-defined interval, and an exception type; determine, based on the at least one bucket and by an artificial intelligence (AI) pattern module, an average exception count for the at least one bucket over the pre-defined interval; collect historical exception data associated with the at least one bucket; compare, by the AI pattern module, the historical exception data associated with the at least one bucket and the average exception count for the at least one bucket; and determine, based on the comparison, an outlier exception pattern for the at least one bucket for the pre-defined interval.

In some embodiments, the exception type is based on at least one of a source component flow, a source component sub-flow, a data center identifier, a server identifier, or an exception identifier.

In some embodiments, executing the computer-readable code is further configured to cause the at least one processing device to: collect metric data associated with the at least one source component; extract, from the metric data, the exception data associated with the at least one source component; generate an exception count for the exception data for the at least one source component and based on the exception type; and generate the at least one bucket based on the exception count, the at least one source component, the pre-defined interval, and the exception type.

In some embodiments, the AI pattern module comprises at least one of a z-score algorithm, an interquartile regression pattern, a quartile regression algorithm, or a standard deviation algorithm.

In some embodiments, the exception type comprises at least one of a checked exception, an error exception, a runtime exception, a logical exception, an argument exception, a null reference exception, or a compilation exception.

In some embodiments, executing the computer-readable code is further configured to cause the at least one processing device to: determine, based on the pre-defined interval, a historical exception pattern for the pre-defined interval; compare the outlier exception pattern and the historical exception pattern for the pre-defined interval; and determine, based on the comparison of the outlier exception pattern and the historical exception pattern, an outlier comparison score for the pre-defined interval, wherein the outlier comparison score indicates at least one of a sharp increase pattern or a consistent pattern.

In some embodiments, executing the computer-readable code is further configured to cause the at least one processing device to: compare the outlier comparison score with a comparison score threshold; identify the sharp increase pattern or the consistent pattern for the outlier comparison score based on the comparison of the outlier comparison score and the comparison score threshold; and generate an alert interface component in an instance where the outlier comparison score comprises the sharp increase pattern. In some embodiments, executing the computer-readable code is further configured to cause the at least one processing device to: generate a report interface component comprising the outlier exception pattern in an instance where the outlier comparison score comprises the consistent pattern for the pre-defined interval; transmit the report interface component to a user device associated with the at least one source component, wherein the user device comprises a graphical user interface (GUI); and trigger a configuration of the GUI of the user device with the report interface component, wherein the GUI indicates the at least one source component and the outlier exception pattern at the pre-defined interval.

In some embodiments, executing the computer-readable code is further configured to cause the at least one processing device to: generate a dashboard interface component comprising the outlier exception pattern for the at least one source component; transmit the dashboard interface component to a user device associated with the at least one source component, wherein the user device comprises a graphical user interface; and trigger a configuration of the GUI of the user device with the dashboard interface component.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for determining and locating network component errors in a distributed network, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for determining and locating network component errors in a distributed network, in accordance with an embodiment of the disclosure;

FIG. 4 a process flow for generating the at least one bucket of exception data, in accordance with an embodiment of the disclosure;

FIG. 5 illustrates a process flow for determining the outlier comparison score and comparing the outlier comparison score to a comparison score threshold, in accordance with an embodiment of the disclosure;

FIG. 6 illustrates a process flow for generating a dashboard interface component and configuring a graphical user interface with the dashboard interface component, in accordance with an embodiment of the disclosure; and

FIG. 7 illustrates a flow diagram for determining and locating network component errors in a distributed network, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's current technology environment, so many components perform so many tasks to keep applications, data centers, servers, and/or the like up and running, and running smoothly without interruption. However, it is extremely difficult for operators of these technical components, operators of these applications, data centers, servers, and/or the like, to be aware of each error or exception that occurs or whether any of these errors or exceptions are part of a broader pattern within the technical components. It is especially difficult to determine these broader patterns of exceptions when the exception patterns only occur once in a 28 day period, or only a handful of times within a month, especially when so much data is collected continuously, and the data is difficult to sift and analyze due to its size and extensiveness. In either case where errors and exceptions must be accurately tracked and identified in real time, and where exception patterns must be accurately and efficiently identified, the level and breadth of data regarding each exception at each technical component can be overwhelming to analyze and understand, especially on both a granular scale (regarding the current instance) and on a broader scale (regarding the entire month's exception counts for each technical component). Thus, in both instances, a system that can determine the exception counts of these technical environments must be efficient and accurate with determining when exceptions arise—in real time or near real time—and when the exceptions are likely to arise again. Thus, a system that can determine and locate network component errors in a distributed network efficiently, accurately, and dynamically is necessary to keep these technical environments and their downstream components and applications running smoothly and without interruption.

Accordingly, the present disclosure provides a system, computer program product, and computer implemented method for determining and locating network component errors in a distributed network. Further, the system may comprise: a memory device with computer-readable program code stored thereon; at least one processing device operatively coupled to the at least one memory device and the at least one communication device, wherein executing the computer-readable code is configured to cause the at least one processing device to: collect, from at least one source component, exception data at a pre-defined interval; group the exception data into at least one bucket based on the at least one source component, the pre-defined interval, and an exception type; and determine, based on the at least one bucket and by an artificial intelligence (AI) pattern module, an average exception count for the at least one bucket over the pre-defined interval. Additionally, the execution of the computer-readable code may be further configured to cause the at least one processing device to: collect historical exception data associated with the at least one bucket; compare, by the AI pattern module, the historical exception data associated with the at least one bucket and the average exception count for the at least one bucket; and determine, based on the comparison, an outlier exception pattern for the at least one bucket for the pre-defined interval.

In other words, the disclosure provides a system for aggregating exception counts within a network (e.g., errors or issues in applications, servers, containers, and/or the like) into pre-defined period data packets for each application, server, container, and/or the like. Using the data packets, the system may use any one of a plurality of AI pattern module comprising different algorithms (e.g., z-score algorithm, standard deviation algorithms, interquartile algorithms, quantile algorithm, and/or the like) for determining outliers or abnormal error values across time periods. In an instance where the AI pattern module returns an abnormal error value indicator (e.g., a great number of exceptions where previously there has not been many exceptions historically) in its outlier exception pattern, the system may generate a report and update a dashboard to indicate the potential problem with the application, server, container, and/or the like. In some embodiments, the system may further be configured to generate an alert comprising a description of the error, which may further comprise a timestamp of the error, the location of the error, and/or the like. Importantly, the system may further analyze the current exception counts at the current period and/or at least one previous period (pre-defined interval) to determine if a pattern is present for the high exception counts that would have otherwise been missed by a manual review. For instance, and where the pre-defined interval is a five minute period, and where each five minute period throughout an entire month is analyzed by the system, there could be multiple buckets per a pre-defined interval, each with their own exception counts, at all of these pre-defined intervals within a month (e.g., at least 8,064 five minute periods in a month of 28 days, and thus way too much data to consider and compare). This is especially true when only one five minute period comprises a high exception count out of the 2,064 other five minute periods.

What is more, the present invention provides a technical solution to a technical problem. As described herein, the technical problem includes the determination and location of network component errors in a distributed network and across many periods of time (e.g., days, weeks, months, years, and/or the like). The technical solution presented herein allows for the accurate, efficient, and dynamic determination and location of network component errors or exceptions, and the identification of exception patterns in the distributed network to prevent and mitigate future exception patterns. In particular, the disclosure provided herein is an improvement over existing solutions to the determination and location of network component errors in a distributed network, (i) with fewer steps to achieve the solution, thus reducing the amount of computing resources, such as processing resources, storage resources, network resources, and/or the like, that are being used (e.g., by only extracting and/or collecting exception data and/or just exception counts for each source component, the system may streamline its analysis and streamline the number of computing resources or processing resources necessary to carry out the description provided herein); (ii) providing a more accurate solution to problem, thus reducing the number of resources required to remedy any errors made due to a less accurate solution (e.g., by using an AI pattern module which is configured to determine the normal patterns of exception counts that can be expected or each technical component in an efficient and accurate manner, without requiring the analysis of each individual exception and its data); (iii) removing manual input and waste from the implementation of the solution, thus improving speed and efficiency of the process and conserving computing resources (e.g., by automatically collecting exception data, performing the analysis, and generating a report interface component or a dashboard interface component, the manual input for analyzing and reviewing each exception and its count may be removed completely); (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

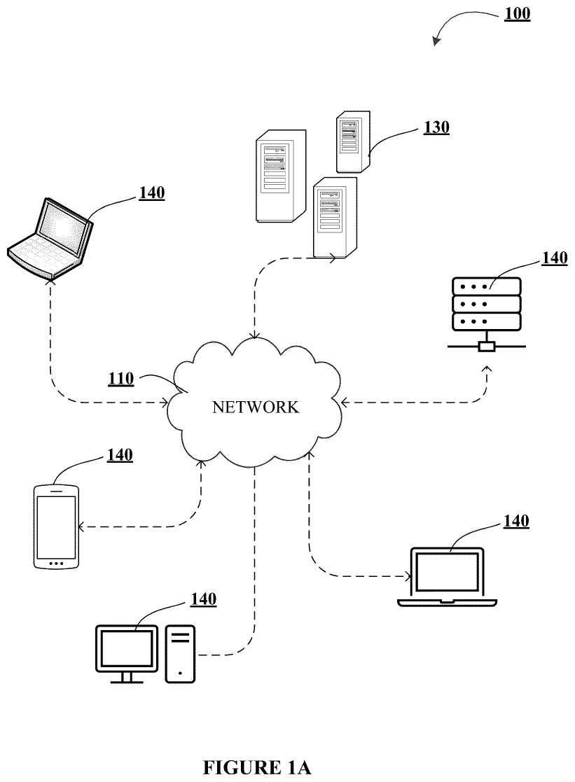

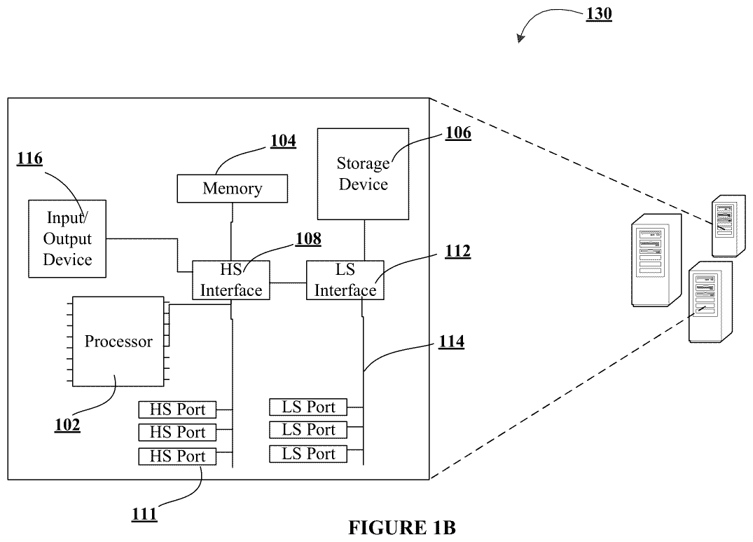

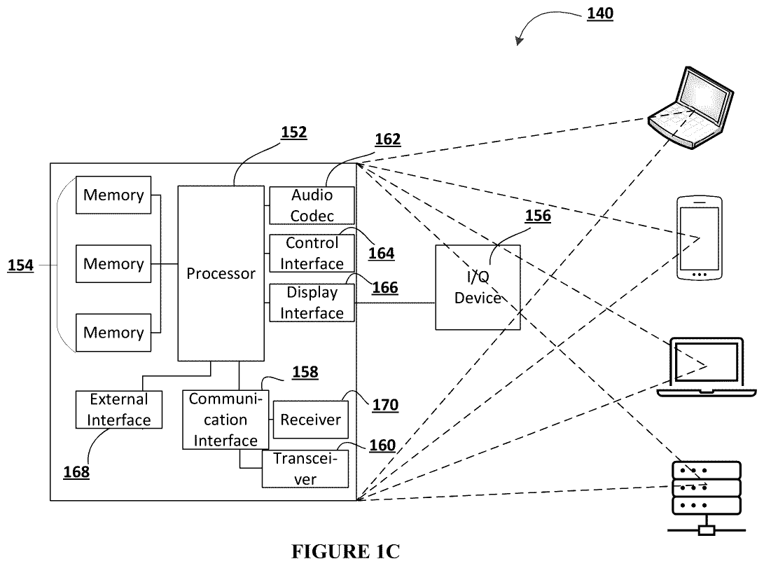

FIGS. 1A-1C illustrate technical components of an exemplary distributed computing environment for determining and locating network component errors in a distributed network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

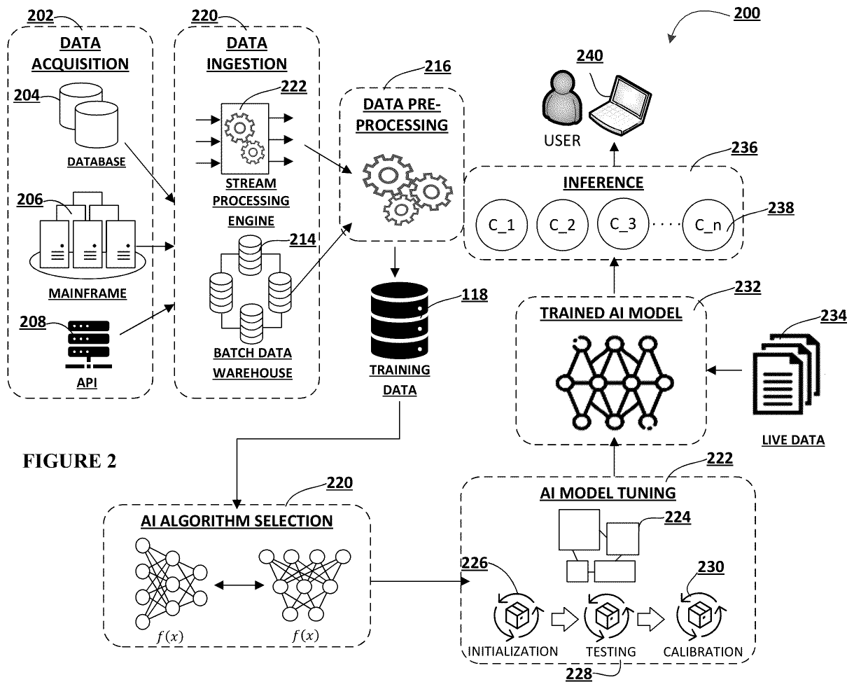

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

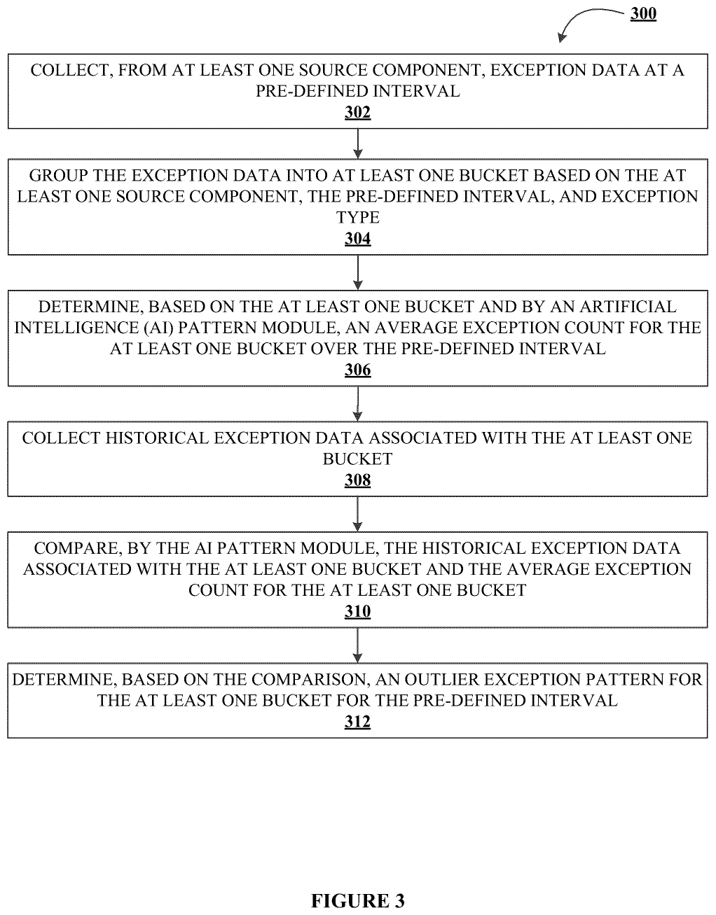

FIG. 3 illustrates a process flow 300 for determining and locating network component errors in a distributed network, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence engine (e.g., such as the AI engine shown in FIG. 2) may perform some or all of the steps described in process flow 300.

As shown in block 302, the process flow 300 may include the step of collecting, from at least one source component, exception data at a pre-defined interval. For example, the system described herein may be configured to extract, collect, and/or receive exception data from at least one source component, whereby the at least one source component may be associated with the network associated with the system (e.g., a network connected to the system, a network housing the system, a network sending and/or receiving data transmission to and/or from the system, and/or the like). In some such embodiments, the at least one source component may comprise an application, a website, a data center, a data center component, a central processing unit (CPU), a server, a container, an environment, and/or the like.

In some such embodiments, the exception data described herein refers to an error or event which causes a computer system or component to be unable to carry out its intended execution or purpose (e.g., an error in carrying out an application's function or purpose, an error or event in a data center, an error or event in a server, and/or the like). In some embodiments, the exception data may be extracted automatically from metric data or metadata of the at least one source component, whereby the system described herein (e.g., system 130 and/or AI engine 200) may automatically extract and classify the exception data from the metric data. In some embodiments, the exception data may comprise losses of data transmission requests and/or data loss, execution errors, runtime errors, syntax errors, communication errors, hardware errors, compilation errors, arithmetic errors, linker errors, semantic errors, execution errors, logical operator errors, memory errors, component failure, power outages, network failures, security breaches, and/or the like.

Additionally, and in some embodiments, the system may collect the exception data at a pre-defined interval, whereby the pre-defined interval may be configurable based on a user input, such as a user input received at a user device associated with the system (e.g., a user device associated with a manager of the system, a user device associated with a manager of the at least one source component, and/or the like). Thus, and in some such embodiments, the pre-defined interval may change based on a user input requesting less data or more data to be collected from the at least one source component and analyzed by the system described herein. In some such embodiments, the pre-defined interval may comprise an interval of every minute, every five minutes, every ten minutes, every fifteen minutes, every thirty minutes, every hour, and/or the like.

As shown in block 304, the process flow 300 may include the step of grouping the exception data into at least one bucket based on the at least one source component, the pre-defined interval, and the exception type. For instance, and in some embodiments, the system may cluster or separate the exception data collected from the source component(s) into at least one bucket(s), whereby each bucket may store a particular type of exception for each source component. Thus, and as described herein, each bucket may comprise all the exceptions (and/or the number of each exception type) of the same type at the same pre-defined interval for the same source component.

In some such embodiments, the system may cluster the exception data collected into a plurality of buckets, whereby each bucket comprises all the exceptions (or the number of exceptions) of the same type at the same pre-defined interval for each same source component. In some embodiments, the system may segment or cluster the exceptions into their respective buckets, and the system may perform an analysis on each bucket to determine a count of each exception type at the pre-defined interval for each source component.

In some embodiments, the exception type may be based on at least one of a source component flow, a source component sub-flow, a data center identifier, a server identifier, or an exception identifier. In some such embodiments, the exception type may be particular to an application (e.g., a source component flow), a sub-application within the application (e.g., a source component sub-flow), a data center identifier where the exception is located and/or where the application/sub-application is running, a server identifier for the application, and/or an exception identifier (such as a name of an exception/name of an exception type). Thus, and in some such embodiments, the exception type may be particular to each application (and even sub-applications), their specific locations (e.g., data center, server, and/or the like), and specific names or types of exception. In some embodiments, the exception type comprises at least one of a checked or unchecked exception (e.g., exceptions that may be expected and planned for or unexpected exceptions, respectively); an error exception (e.g., invalid user input, code error, device failure, loss of network connection, not enough memory to run an application, a memory conflict with another program, a file that is unavailable that is attempting to be accessed, and/or the like); a runtime exception (e.g., a runtime error or program/file error); a logical exception (e.g., error in program logic); an argument exception (e.g., when a passed argument does not meet the parameter specification of the current invoked method or command); a null reference exception (e.g., when access is attempted for a null value or null type); or a compilation exception (e.g., syntax error).

By way of non-limiting example, and where the pre-defined interval is set at five minutes, the at least one source component the exception data was collected from comprises a server A, server B, and a server C, and server A has execution exception and runtime exception in that pre-defined interval, server B also has execution exception and linker exception in that pre-defined interval, and server C has linker exception and runtime exception. Then, in such an example, the system may generate a plurality of buckets, whereby a first bucket may comprise the execution exceptions for server A, the second bucket may comprise the runtime exception for server A, the third bucket may comprise the execution exception for server B, the fourth bucket comprises the linker exception for server B, the fifth bucket comprises the linker exception for server C, and the sixth bucket comprises the runtime exception for server C. In some embodiments, and where server A has execution exceptions for multiple components (e.g., component A and component B), then the system may generate multiple buckets for the multiple components (e.g., a bucket for the execution exceptions of component A and a bucket for the execution exceptions of component B).

Thus, and as used herein, the term “bucket” refers a memory component configured or programmed to store data records. Such buckets may be configured to store data for each pre-defined interval and for each source component, which allows the system to segment the data for each source component for separate analysis against each source component's past or historical data, without muddling the data for each bucket with data belonging to another source component or another exception. Thus, the data within each bucket is refined and limited for greater processing speed, lower storage requirements, and to provide greater accuracy in the system's analysis for each source component.

As shown in block 306, the process flow 300 may include the step of determining, based on the at least one bucket and by an artificial intelligence (AI) pattern module, an average exception count for the at least one bucket over the pre-defined interval. For example, the system may use a pre-trained AI pattern module, which is configured to identify patterns and unexpected outliers to the patterns for each bucket and for each pre-defined interval. In some embodiments, the AI pattern module may be trained on past or historical exception data (e.g., exception counts for each exception type) for each source component, such that the AI pattern module may easily and efficiently determine outlier exception data (e.g., outlier exception counts) which may be abnormal compared to historical exception patterns for the source component(s).

In some embodiments, the system may determine—using the AI pattern module—an average exception count for the exceptions collected for the pre-defined interval (e.g., count of exceptions within the exception type over the pre-defined interval), such that the overall average of the particular exception and the number of times the exception was detected over the pre-defined interval may be determined by the system. Thus, and where the exception count for the pre-defined interval comprises an exception count of 3000 over a five minute period, then the average exception count may comprise a value of 600 exceptions per a minute, ten exceptions a minute, and/or the like. The system may use this average exception count and compare the average exception count to historical exception data and its average historical exception count (e.g., which could comprise a value of 4 exceptions over five minutes, or 0.8 exceptions per minute).

In some embodiments, the AI pattern module comprises at least one of a z-score algorithm, an interquartile regression pattern, a quantile regression algorithm, and/or a standard deviation algorithm. Thus, and as discussed herein, the AI pattern module may comprise a z-score algorithm, which is configured to determine the difference between data points of the exception counts and the average of the data points, to determine the standard deviation and a bell curve to determine which data points are abnormal (are outliers) for the exception counts of each exception type. In some embodiments, the AI pattern module may comprise an interquartile regression pattern or algorithm which may be configured to determine the outliers based on quartile regions and their fences or boundaries. In some embodiments, the AI pattern module may comprise a quantile regression algorithm which may be configured to determine the quantiles in a standard deviation over data points associated with different exception counts, and the outliers compared to each quantile. Further, and in some embodiments, the AI pattern module may comprise another standard deviation algorithm which may not be explicitly listed herein, but may be understood by a person of skill in the art.

As shown in block 308, the process flow 300 may include the step of collecting historical exception data associated with the at least one bucket. For instance, and in some such embodiments, the system may collect historical exception data associated with the at least one source component described hereinabove. Further, and in some such embodiments, the system may collect the historical exception data associated with the source component(s) at historical pre-defined intervals, which may match the same interval as the pre-defined interval for collecting the current exception data (e.g., every minute, every five minutes, every ten minutes, every fifteen minutes, every thirty minutes, every hour, and/or the like). For instance, the system may collect historical exception data associated with the source component(s), such that the system keeps a running database and/or a running storage of the historical exception data from each connected source component.

In some embodiments, the database and/or storage component that continuously collects the historical exception data for each source component may be operatively coupled to the system itself, managed by the system, and/or located remote from the system (e.g., such that the system sends a data transmission request over a network to the database and/or storage component for the historical exception data). In some embodiments, and where the system sends a data transmission request to the remote storage component and/or database for the historical exception data, the system may limit its data transmission request(s) to only those source components and their historical exception data that are current associated with a bucket from block 304. Thus, and in this manner, the system may limit its historical exception data necessary to analyze the buckets of the source components that currently have errors that were sorted into a bucket, and thus, the system may analyze only the necessary data for each source component and not extra or unimportant data to determine the outlier exception pattern(s) for the source component(s).

In some embodiments, and in order to generate a wholistic view of all the source components considered by the system, the system may cluster each piece of data from the exception data collected into their respective buckets, such that all the exception data for each source component is considered to generate the outlier exception pattern. In such embodiments, the historical exception data for the source components may collected to generate outlier exception patterns for all the source components and whether the outliers should indicate an issue that should or can be mitigated (e.g., a pattern of exceptions may be mitigated if the exceptions continue to occur at the same time(s), regularly).

Further, and in some embodiments, the system may collect the historical exception data at the same pre-defined interval configured from blocks 302-304. Thus, and in the example provided hereinabove, where the pre-defined interval was five minutes, the historical pre-defined interval may also be five minutes. Such a matching of the pre-defined interval and the historical pre-defined interval may allow the system to use the historical metric data collected at the same time periods as a controlled set of exception patterns for the source component(s).

As shown in block 310, the process flow 300 may include the step of comparing, by the AI pattern module, the historical exception data associated with the at least one bucket and the average exception count for the at least one bucket. For instance, the system may compare—using the AI pattern module—the historical exception data associated with the same source component, the same exception type, and the same pre-defined interval as the at least one bucket with the average exception count for the at least one bucket. Thus, and by using the AI pattern module, the system can identify past or historical exception data points, the normal historical exception data points (e.g., within a standard deviation bell curve), which exception data points for the current exception data fit within the bell curve (are normal based on the standard deviations of the bell curve) and which, if any, current exception data points are abnormal as compared to the bell curve's standard deviations.

Thus, and in some such embodiments, the system may compare the historical exception average counts and the average exception count for the current exception data, using the AI pattern module, to determine which—if any—of the average exception counts are outside the bell curve or standard deviations of the AI pattern module. Those average exception counts that are outside the standard deviations of the AI pattern module (e.g., which may be based on the historical average exception counts for the source component) may be determined as outliers, and thus, flagged by the system.

As shown in block 312, the process flow 300 may include the step of determining, based on the comparison, an outlier exception pattern for the at least one bucket for the pre-defined interval. For instance, the system may determine—using the comparison discussed hereinabove with respect to block 310—an outlier exception pattern for the at least one bucket. In some such embodiments, the outlier exception pattern may comprise one or more data points or one or more values indicating the average exception count for source components at issue, and which are determined as outliers compared to their historical exception data. Thus, and in some such embodiments, the average exception count for each source component analyzed by the system for the pre-defined interval that are determined as an outlier as compared to their associated historical exception data may be determined as the outlier exception pattern. Therefore, and in some such embodiments, the outlier exception pattern for one source component may comprise a single value (e.g., a single average exception count), and/or the outlier exception count for a plurality of source components may comprise the plurality of values of the plurality of average exception counts that are determined as outliers for the plurality of source components. In this manner, the outlier exception pattern may comprise the value(s) of all the source components analyzed for the pre-defined interval that comprise an outlier for their average exception count.

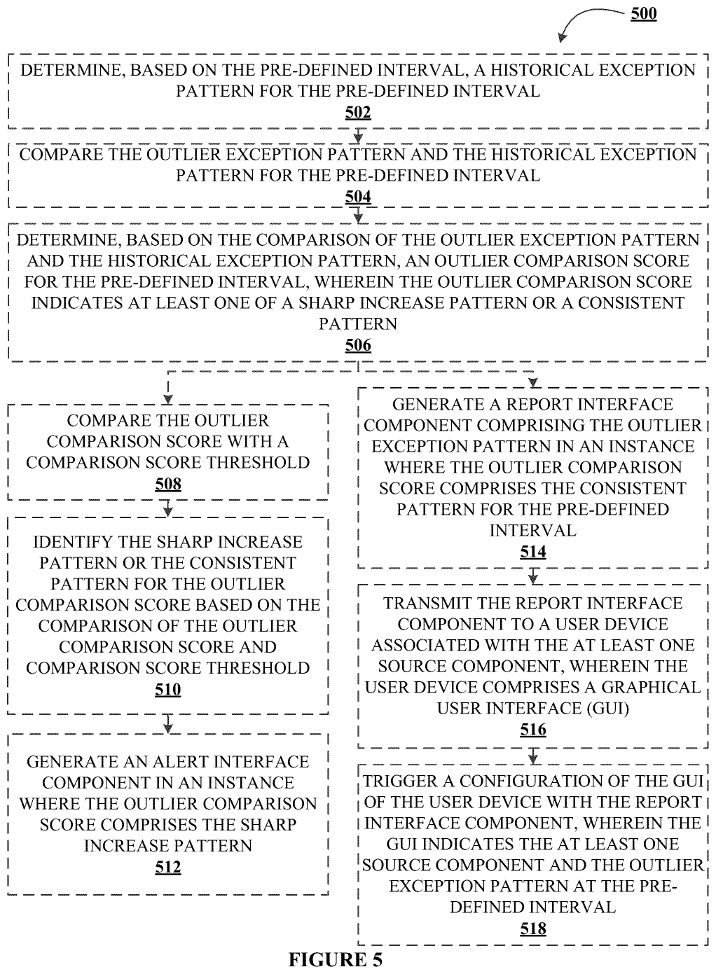

Therefore, and by way of non-limiting example, where the average exception count comprised 3000 exceptions over a five minute interval (e.g., 60 exceptions every one minute, on average), and the historical exception data for that source component indicates that the historical average exception count comprises a value of 1 exception a minute, this difference between 60 exceptions a minute and 1 exception a minute may be considered an outlier based on the drastic change to the average counts between the two values. In some embodiments, sharp increases in these patterns (historical average exception counts and current average exception counts) and/or sharp decreases may be used by the system to determine whether an alert or report should be sent to a user associated with the source component at issue (e.g., showing the abnormal outlier of the exception counts). Such an embodiments is described in further detail below, in FIG. 5.

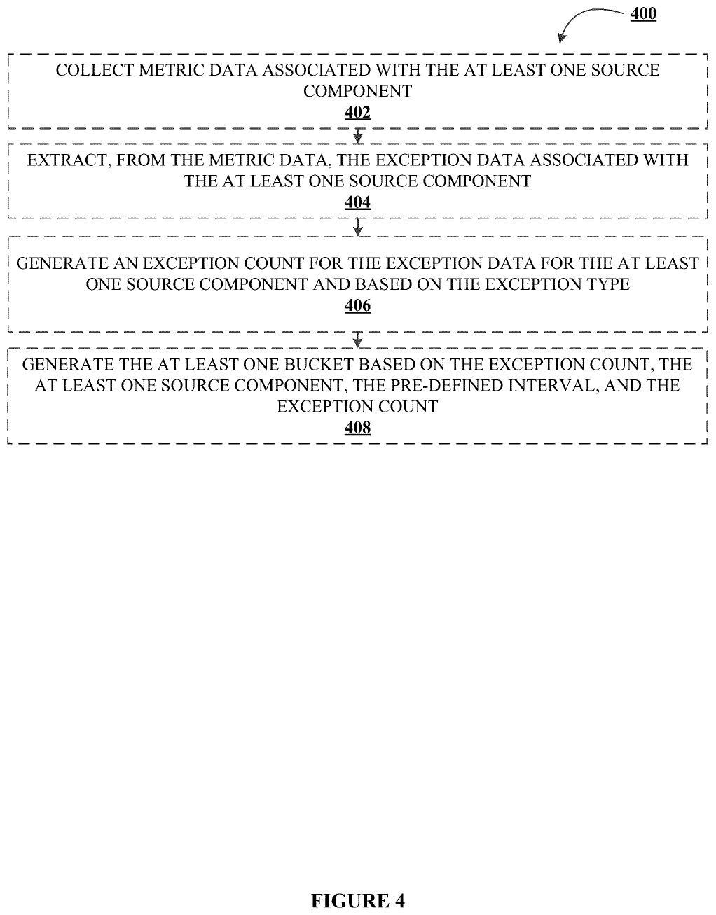

FIG. 4 illustrates a process flow 400 for generating the at least one bucket of exception data, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) may perform some or all of the steps described in process flow 400.

In some embodiments, and as shown in block 402, the process flow 400 may include the step of collecting metric data associated with the at least one source component. For instance, and in some embodiments, the system may collect and/or receive data from the at least one source component in a network associated with the system (e.g., a network connected to the system, a network housing the system, a network sending and/or receiving data transmission to and/or from the system, and/or the like). In some such embodiments, the metric data collected and/or received by the system may comprise the metadata associated with the source component(s), whereby such metadata may comprise the exception data and any other such data regarding the current performance of the source component, its location data, its component data, and/or the like. In some embodiments, the metric data may comprise, but is not limited to, a response time for the at least one source component, heat data of the at least one source component, unresponsiveness of the source component, losses of data transmission requests and data loss, execution errors, runtime errors, syntax errors, communication errors, hardware errors, compilation errors, arithmetic errors, linker errors, semantic errors, execution errors, logical operator errors, memory errors, component failure, power outages, network failures, security breaches, and/or the like.

In some embodiments, the system itself may collect and separate or organize all the metric data as the metric data is received from a network (and/or from the at least one source component directly via a network). In some embodiments, the at least one source component may be configured (e.g., programmed) to automatically and continuously transmit its metric data to the system for continuous collection. In some embodiments, the at least one source component may be configured (e.g., programmed) to automatically transmit its metric data to the system at pre-defined intervals, such as but not limited to every minute, every five minutes, every six minutes, every ten minutes, every fifteen minutes, every thirty minutes, every hour, and/or the like. Additionally, and/or alternatively, the system itself may be programmed to send data transmission requests to the at least one source components for the source component's metric data and receive, based on the data transmission requests, the metric data from each source component. Such data transmission requests may be generated and transmitted at the pre-defined intervals described hereinabove.

Additionally, and/or alternatively, the system may only collect the historical exception data for each of the source components that are currently being analyzed by the system (e.g., that are currently associated with a bucket at the current pre-defined interval). Thus, and in this manner, the system may limit its collection of historical exception data to only the historical exception data necessary to perform its analysis and determine the outlier exception patterns for the current buckets.

Upon collecting the metric data from the source component(s), the system may parse and extract only the exception data from the metric data for further analysis (such as the analysis performed in FIGS. 3-6). Thus, and in such embodiments where data is collected a pre-defined intervals, and the system extracts on the exception data, the system may avoid analyzing too much data as opposed to a continuous collection of data from the at least one source component(s) and data that is unimportant in performing its analysis on the exception data.

In some embodiments, and as shown in block 404, the process flow 400 may include the step of extracting, from the metric data, the exception data associated with the at least one source component. For instance, and in some embodiments, the system may extract, from the metric data, the exception data for each of the errors that have occurred at the source component(s) within the pre-defined interval (e.g., where the pre-defined interval is every five minutes, then the system may extract the exceptions that occurred within the past five minutes at the time of collection for the source component(s)). In some such embodiments, the system may parse, analyze, and extract all the data associated with or indicating an exception or error that occurred within the pre-defined interval. In some embodiments, the exceptions may be identified using a natural language processor (NLP) configured to identify exceptions, the exception names or types, and/or the likes. In some embodiments, the exceptions may be identified based on the source component's metadata, whether the process properly run according to the source component's intended function, what output was generated by the source component (whether the output was expected), and/or the like. In some embodiments, and in order to streamline the processes described herein, the system may be configured to extract only a count of the exceptions and their exception types within the pre-defined interval, and input those exception counts directly to a bucket configured for the specific exception type.

In some embodiments, and as shown in block 406, the process flow 400 may include the step of generating an exception count for the exception data for the at least one source component and based on the exception type. In some such embodiments, the system may generate an exception count from the exception data for the at least one source component, whereby the exception count may comprise a count or numerical sum of each type of the exception that occurred within or at the system component within the pre-defined interval. In this manner, and in such an embodiment, the metadata for each exception may not be necessary (e.g., the time of the exception, the exception name, a summary of the exception, and/or the like) for the system to perform its function of determining the outlier exception pattern, and any other such functions as those described herein. Thus, the exception count may comprise the overall number of exceptions, for each type of exception, for each source component analyzed by the system (e.g., for each source component where metric data comprises exceptions that were extracted).

In some embodiments, and as shown in block 408, the process flow 400 may include the step of generating the at least one bucket based on the exception count, the at least one source component, the pre-defined interval, and the exception count. For instance, and in some such embodiments, the system may generate at least one bucket (like the bucket described hereinabove with respect to block 304) for each source component comprising an exception and for each exception type (e.g., one bucket may be used for a specific exception type for a specific source component). Thus, and similar to the description described hereinabove, the bucket may comprise the data of each of the exceptions identified in the pre-defined interval, such that the system may perform its analysis and determine the outlier exception pattern for each bucket (like that shown and described in FIG. 3).

FIG. 5 illustrates a process flow 500 for determining the outlier comparison score and comparing the outlier comparison score to a comparison score threshold, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) may perform some or all the steps described in process flow 500.

In some embodiments, and as shown in block 502, the process flow 500 may include the step of determining, based on the pre-defined interval, a historical exception pattern for the pre-defined interval. For example, and in some such embodiments, the system may determine—based on the pre-defined interval described hereinabove—a historical exception pattern for the pre-defined interval (the historical pre-defined intervals). Thus, such a historical exception pattern may comprise a plurality of data points of historical exception counts which may be used to generate the standard deviations of the bell curve (e.g., what is considered normal).

In some embodiments, and as shown in block 504, the process flow 500 may include the step of comparing the outlier exception pattern and the historical exception pattern for the pre-defined interval. For instance, and in some such embodiments, the system may compare the outlier exception pattern determined in block 312 to the historical exception pattern to determine an outlier comparison score between the data point(s) of the outlier exception pattern and the data points of the historical exception pattern. Thus, and in some such embodiments, the outlier exception pattern may be applied to the historical exception pattern, and the system may determine where the outlier exception pattern fits in the historical exception pattern (e.g., does the outlier exception pattern sit outside the bell curve or sit outside the ranges of −1 and 1 of the bell curve, which may indicate an abnormality, or inside the bell curve or inside the range of −1 to 1, which may indicate the outlier exception pattern is normal). Thus, and as described hereinabove, each historical exception pattern may be based on a particular pre-defined interval (e.g., a first five minutes of an hour may be associated with a different historical exception pattern than a second five minutes of an hour).

In some embodiments, and as shown in block 506, the process flow 500 may include the step of determining, based on the comparison of the outlier exception pattern and the historical exception pattern, an outlier comparison score for the pre-defined interval, wherein the outlier comparison score indicates at least one of a sharp increase pattern or a consistent pattern. For instance, and in some such embodiments, the system may determine, based on the comparison of the outlier exception pattern and the historical exception pattern, an outlier comparison score for the pre-defined interval at issue. By way of non-limiting example, and where the outlier exception pattern applied to the historical exception pattern shows the outlier exception pattern falls into the third deviation from the center of the bell curve (e.g., between the third and fourth deviations which may indicate a 0.1 percent chance of falling into the bell curve), then the system may determine the outlier comparison score is same as the percentage of the standard deviation (0.1) and/or the same as standard deviation (e.g., 3.5).

In some embodiments, the outlier comparison score may comprise and/or be associated with a sharp increase pattern and/or a consistent pattern. In some embodiments a sharp increase pattern may indicate a sharp increase between the outlier exception pattern and historical exception pattern's median (e.g., the value at the 0 of the bell curve), with the outlier exception pattern being greater than the historical exception pattern's median. In some embodiments, the consistent pattern may comprise a consistent or similar value of the outlier exception pattern and historical exception pattern's median (e.g., where the value of the outlier exception pattern is within the first standard deviation of the historical exception pattern's median.

In some embodiments, the sharp increase pattern may indicate the outlier exception pattern comprises a value that falls within a more than two standard deviations above the immediately previous historical exception data point (e.g., the historical exception data point from the previous five minutes where the pre-defined interval was also five minutes). In some embodiments, the consistent pattern may indicate the outlier exception comprises a value that falls within the same standard deviation as the previous exception data point (e.g., the historical exception data point from the previous five minutes where the pre-defined interval was also five minutes).

In some embodiments, and as shown in block 508, the process flow 500 may include the step of comparing the outlier comparison score with a comparison score threshold. For instance, and in some such embodiments, the system may compare the outlier comparison score with a comparison score threshold, whereby the comparison score threshold may be pre-defined by a user of the system, such as a user associated with an entity that owns and/or operates the at least one source component, a user associated with a manager of the system, and/or the like, and/or the comparison score threshold may be defined by the system itself based on past or historical analysis of exception patterns and what was an acceptable difference between the outlier exception pattern and the historical exception pattern.

In some such embodiments, the comparison score threshold may determine the level of difference between outlier exception pattern and the historical exception pattern to indicate the outlier exception pattern is too great a difference and indicates an abnormality that needs to be addressed (e.g., a large number of exceptions are present and need to be mitigated or solved). Thus, and in some embodiments, the outlier comparison score may be compared with comparison score threshold to determine if the outlier comparison score indicates the exceptions with a large number over the historical exception pattern (e.g., the outlier comparison score indicates the outlier exception pattern is greater than the historical exception pattern) should be addressed.

Further, and in some such embodiments, the outlier comparison score meeting or exceeding the comparison score threshold may be compared with other outlier comparison scores to determine if there is a pattern of high exception levels that peak every once in a while, but still do not occur regularly to affect the bell curve. In some such embodiments, the system may then identify each pattern of exceptions, even those that happen in one five minute period for one day every month month (which may be compared to every five minute period, every hour, every day, of every month, a value of patterns that could equal over 8,600 five minute periods within a month to analyze, which may be exponentially increased by 12 months).

In some embodiments, and as shown in block 510, the process flow 500 may include the step of identifying the sharp increase pattern or the consistent pattern for the outlier comparison score based on the comparison of the outlier comparison score and comparison score threshold. For example, and in some embodiments, the system may identify which of the sharp increase pattern and/or the consistent pattern is applicable for the outlier comparison score for the outlier comparison score based on the outlier comparison score with the comparison score threshold by determining if the outlier comparison score meets or exceeds the comparison score threshold. In some embodiments, and where the outlier comparison score does not meet or exceed the comparison score threshold, the outlier comparison score may comprise consistent pattern. In some embodiments, and where the outlier comparison score does meet or exceed the comparison score threshold, the outlier comparison score may comprise sharp increase pattern.

In some embodiments, and as shown in block 512, the process flow 500 may include the step of generating an alert interface component in an instance where the outlier comparison score comprises the sharp increase pattern. For instance, and in such embodiments, the system may generate an alert interface component which comprises the data regarding the source component associated with the outlier comparison score that comprises or is associated with the sharp increase pattern (e.g., the source component identifier, the exception type, the exception count, whether there is a pattern of high exceptions and what is the pattern (e.g., the date and time expected for the pattern), and/or the like). Such an alert interface component may comprise the data associated with the source component for the outlier comparison score comprising the sharp increase pattern in computer-readable format, which may then be transmitted to a user device comprising a graphical user interface, and may be used to configure the graphical user interface of the user device to show the data of the outlier comparison score associated with the sharp increase pattern (e.g., the source component identifier, the exception type, the exception count, whether there is a pattern of high exceptions and what is the pattern (e.g., the date and time expected for the pattern), and/or the like). In some such embodiments, the alert interface component may show a pop-up notification on the user device's by configuring the user device's graphical user interface automatically and in near real time to identifying the sharp increase pattern.

In some embodiments, and as shown in block 514, the process flow 500 may include the step of generating a report interface component comprising the outlier exception pattern in an instance where the outlier comparison score comprises the consistent pattern for the pre-defined interval. For instance, and in some such embodiments, the system may generate a report interface component comprising the exception data of each of the source components analyzed in the at least one bucket at the current pre-defined interval when the at least one bucket is associated with an outlier exception pattern that is associated with a high outlier comparison score (based on the comparison with the comparison score threshold) at an identified pattern that is inconsistent through the entire period of time (e.g., one or two times a month, multiple times a month but not enough to affect the bell curve, and/or the like). Thus, and in some embodiments, the report interface component may comprise data of a plurality of source components, their outlier exception pattern data, and the other such data as that described herein (e.g., outlier exception pattern, outlier comparison score, associated bell curve and standard deviation data, and/or the like). In such embodiments, the report interface component may comprise such data in a computer-readable medium which may be transmitted to a user device associated with the system and/or the source component.

In some embodiments, and as shown in block 516, the process flow 500 may include the step of transmitting the repot interface component to a user device associated with the at least one source component, wherein the user device comprises a graphical user interface (GUI). For instance, and in some such embodiments, the system may transmit the report interface component to a user device associated with the system (e.g., a user device associated with a manager of the system, a user device associated with a manager of the at least one source component, and/or the like).

In some embodiments, and as shown in block 518, the process flow 500 may include the step of triggering a configuration of the GUI of the user device with the report interface component, wherein the GUI indicates the at least one source component and the outlier exception pattern at the pre-defined interval. Thus, and in some such embodiments, the system—by transmitting the report interface component—may automatically trigger the configuration of the GUI of the user device to show the data of the report interface component.

Further, and in some embodiments, the system may trigger the configuration of user device's GUI to show the expected patterns of the source components when the source component comprises a sharp increase pattern as a pattern over different, various times over many periods of time (such as over a few periods of pre-defined intervals within many pre-defined intervals in a month period, and/or the like).

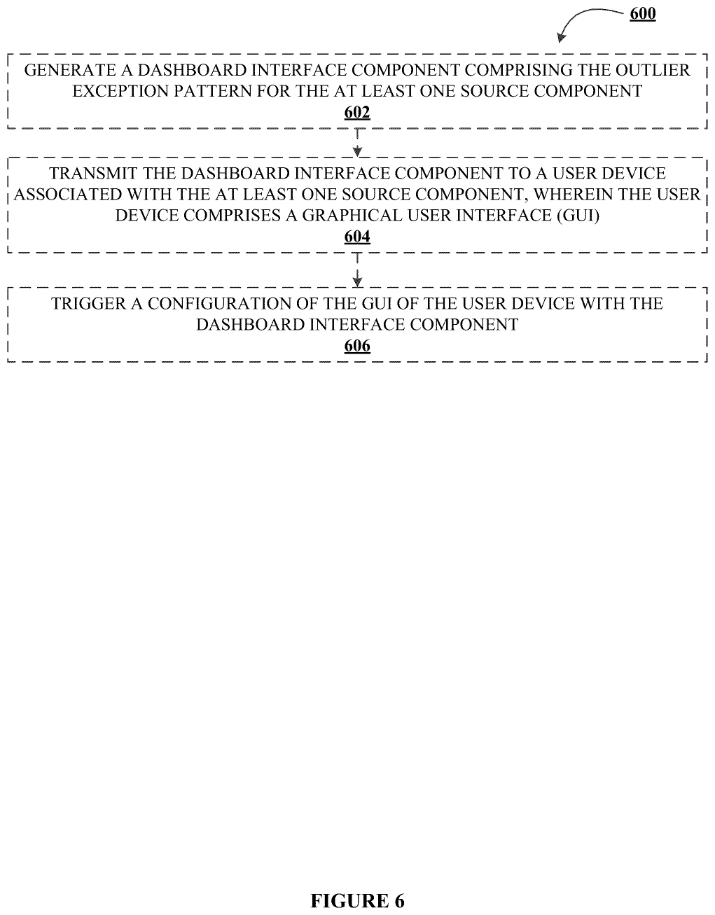

FIG. 6 illustrates a process flow 600 for generating a dashboard interface component and configuring a graphical user interface with the dashboard interface component, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an artificial intelligence engine (e.g., such as the AI engine shown in FIG. 2) may perform some or all of the steps described in process flow 600.

In some embodiment, and as shown in block 602, the process flow 600 may include the step of generating a dashboard interface component comprising the outlier exception pattern for the at least one source component. For example, and in some such embodiments, the system may generate a dashboard interface component comprising the exception data of the source component(s) at the current pre-defined interval and/or at historical pre-defined intervals. Further, and in some such embodiments, the dashboard interface component may comprise the exception data and its associated data (e.g., source component identifier; location of exception such as a geographic location, component identifier, server location, data center location, and/or the like; timestamp of latest pre-defined interval data, and any other such data discussed herein) in a computer figurable format, such that the exception data may be used to render a graphical user interface (GUI) of a user device that receives the dashboard interface component with the information of the exception data. Thus, and in some such embodiments, the exception data in the dashboard interface component may comprise computer readable data which may be used to render the GUI of the user device to show the exception data and its associated data in a human-readable format.

In some embodiments, and as shown in block 604, the process flow 600 may include the step of transmitting the dashboard interface component to a user device associated with the at least one source component, wherein the user device comprises a graphical user interface (GUI). For example, and in some such embodiments, the system may transmit the dashboard interface component to a user device via a network (similar to the network shown and described above with respect to FIG. 1A). Such a user device may be associated with the source component (e.g., a user device associated with an entity that operates and/or owns the source component), a user device associated with the system (e.g., a user device associated with an entity that operates the system), and/or the like. For instance, and in some such embodiments, the system may transmit the dashboard interface component to a user device, whereby the user device may be associated with a manager of the system; a manager, operator, or owner of the at least one source component; and/or the like. In some such embodiments, the user device that will receive the dashboard interface component may be pre-determined and set within the system (e.g., by a manager of the system selecting a user device and/or an associated user to receive the dashboard interface component and/or by a manager of the source component(s) selecting the user device and/or the associated user to receive the dashboard interface component). In some embodiments, the dashboard interface component may be automatically transmitted to the user device in real time or near real time once the dashboard interface component has been generated and/or updated.

In some embodiments, and as shown in block 606, the process flow 600 may include the step of triggering a configuration of the GUI of the user device with the dashboard interface component. For instance, and in some such embodiments, the system may trigger a configuration of the GUI of the recipient user device to automatically and in real time or near real time show the data of the exception data at the current instance for the at least one source component to a user of the user device. In some such embodiments, the dashboard interface component may comprise a plurality of source components and their exception data, such that the configured GUI of the user device is not limited to only one source component and its current exception data. In some embodiments, the dashboard interface component may comprise at least one alert indicating when the data points of the exception data (e.g., the outlier exception data) exceeds the historical exception pattern and/or the outlier comparison score meets or exceeds the comparison score threshold.

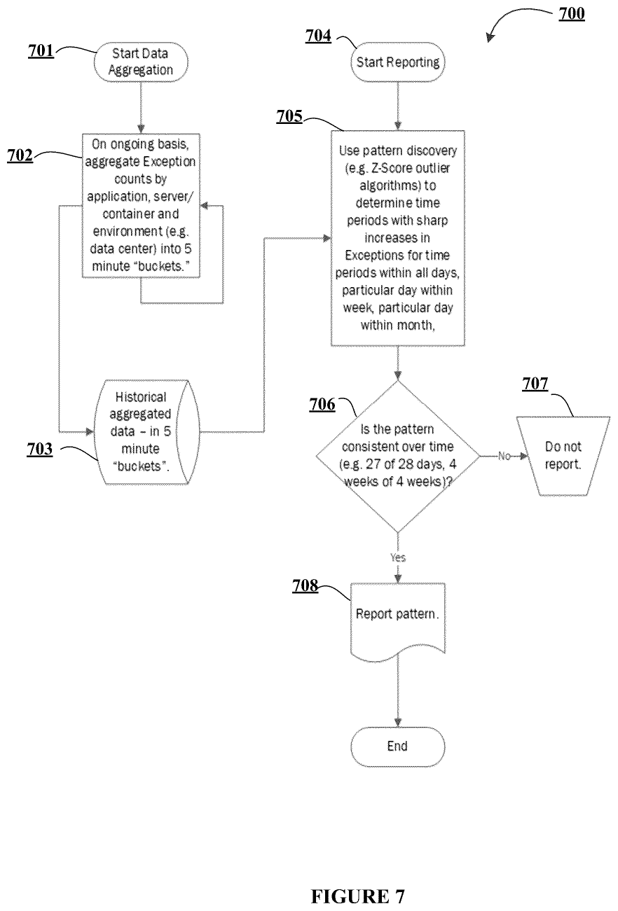

FIG. 7 illustrates a flow diagram 700 for determining and locating network component errors in a distributed network, in accordance with an embodiment of the disclosure. In some embodiments, a system (e.g., similar to one or more of the systems described herein with respect to FIGS. 1A-1C) may perform one or more of the steps of flow diagram 700. For example, a system (e.g., the system 130 described herein with respect to FIG. 1A-1C) may perform the steps of flow diagram 700. In some embodiments, an artificial intelligence engine (e.g., such as the AI engine shown in FIG. 2) may perform some or all of the steps described in flow diagram 700.

As shown in flow diagram 700, the overall process described herein throughout this disclosure is provided as an overall flow diagram. For example, and as shown in block 701, the process may begin by starting the data aggregation (e.g., collecting the metric data associated with at least one source component). In such an embodiment, the system may further parse and extract the exception data of the source component and use the exception counts for each exception type and for the pre-defined interval of the source component to input to block 702. In some embodiments, the data aggregation of block 701 may comprise a data aggregation of the exceptions for the source component at the pre-defined interval.

Further, and as shown in bock 702, the process may continue with aggregating the exception counts from the exceptions aggregated in block 701. Thus, and as shown in block 702, the system may collect and group the exception counts in block 702 based on source component (e.g., application, server, container, data center, sub application, and/or the like) into five minute buckets (e.g., at a pre-defined interval for the bucket(s)).

Further, and as shown in block 703, the system may collect and/or store the historical aggregated data for the source components identified in block 702, which in some embodiments, may be stored in a similar manner to the buckets described in block 702 (e.g., in five minute buckets). Thus, the comparison of the current exception data and the historical exception data may be based on the same time for the data collection (e.g., every five minutes for collection may allow for the system to always analyze the exception on the hour, at five minutes after the hour, at ten minutes after the hour, at fifteen minutes past the hour, and/or the like).

Additionally, and as shown in block 704, the system may continue the process by starting the reporting section of the process (e.g., which may be tasked with generating the dashboard interface component, the report interface component, and/or the like). As shown in block 705, the process may continue by using an AI pattern module (e.g., a z-score algorithm, a standard deviation module, and/or the like) to determine patterns of the exceptions, outliers of exception patterns, sharp increases in exceptions, and/or the like. Thus, and as shown in block 703, the process may comprise the use of the AI pattern module module (which may comprise the z-score algorithm, interquartile regression module, quantile regression algorithm, and/or the like) to determine the exception patterns for the source component(s) based on the current exception data and the historical exception patterns for each source component. Further, and in such embodiments, the system may determine if the periods comprise sharp increases in exceptions for time periods within all days, particular days within a week or a particular week, a particular day within the month, and/or the like.

Further, and as shown in block 706, the process may continue by determining if the outlier exception pattern is consistent over time (e.g., consistent over 27 or 28 days or a full month, over four weeks, and/or the like), or in other words, outlier comparison score comprises a sharp increase pattern at the same time every few weeks, every same day of the month, every week, every particular time at a particular day in a month, and/or the like. In an instance where there are no patterns of high exception data, then the system may not send a report interface component to a user of a user device.

In some embodiments, and as shown in block 708, the system may determine it should generate and transmit a report interface component in an instance where a consistent pattern is not detected for the high exception data over a month period or four week period. Thus, and where a consistent pattern is not detected, the high exception counts and their underlying issues cannot be resolved pro-actively.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system. ” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for determining and locating network component errors in a distributed network, the system comprising:
a memory device with computer-readable program code stored thereon;
at least one processing device operatively coupled to the at least one memory device and the at least one communication device, wherein executing the computer-readable code is configured to cause the at least one processing device to:
collect, from at least one source component, exception data at a pre-defined interval;
group the exception data into at least one bucket based on the at least one source component, the pre-defined interval, and an exception type;
determine, based on the at least one bucket and by an artificial intelligence (AI) pattern module, an average exception count for the at least one bucket over the pre-defined interval;
collect historical exception data associated with the at least one bucket;
compare, by the AI pattern module, the historical exception data associated with the at least one bucket and the average exception count for the at least one bucket; and
determine, based on the comparison, an outlier exception pattern for the at least one bucket for the pre-defined interval.

2. The system of claim 1, wherein the exception type is based on at least one of a source component flow, a source component sub-flow, a data center identifier, a server identifier, or an exception identifier.

3. The system of claim 1, wherein executing the computer-readable code is further configured to cause the at least one processing device to:
collect metric data associated with the at least one source component;
extract, from the metric data, the exception data associated with the at least one source component;
generate an exception count for the exception data for the at least one source component and based on the exception type; and
generate the at least one bucket based on the exception count, the at least one source component, the pre-defined interval, and the exception type.

4. The system of claim 1, wherein the AI pattern module comprises at least one of a z-score algorithm, an interquartile regression pattern, a quartile regression algorithm, or a standard deviation algorithm.

5. The system of claim 1, wherein the exception type comprises at least one of a checked exception, an error exception, a runtime exception, a logical exception, an argument exception, a null reference exception, or a compilation exception.

6. The system of claim 1, wherein executing the computer-readable code is further configured to cause the at least one processing device to:
determine, based on the pre-defined interval, a historical exception pattern for the pre-defined interval;
compare the outlier exception pattern and the historical exception pattern for the pre-defined interval; and
determine, based on the comparison of the outlier exception pattern and the historical exception pattern, an outlier comparison score for the pre-defined interval, wherein the outlier comparison score indicates at least one of a sharp increase pattern or a consistent pattern.

7. The system of claim 6, wherein executing the computer-readable code is further configured to cause the at least one processing device to:
compare the outlier comparison score with a comparison score threshold;
identify the sharp increase pattern or the consistent pattern for the outlier comparison score based on the comparison of the outlier comparison score and the comparison score threshold; and
generate an alert interface component in an instance where the outlier comparison score comprises the sharp increase pattern.

8. The system of claim 6, wherein executing the computer-readable code is further configured to cause the at least one processing device to:
generate a report interface component comprising the outlier exception pattern in an instance where the outlier comparison score comprises the consistent pattern for the pre-defined interval;
transmit the report interface component to a user device associated with the at least one source component, wherein the user device comprises a graphical user interface (GUI); and
trigger a configuration of the GUI of the user device with the report interface component, wherein the GUI indicates the at least one source component and the outlier exception pattern at the pre-defined interval.

9. The system of claim 1, wherein executing the computer-readable code is further configured to cause the at least one processing device to:
generate a dashboard interface component comprising the outlier exception pattern for the at least one source component;
transmit the dashboard interface component to a user device associated with the at least one source component, wherein the user device comprises a graphical user interface; and
trigger a configuration of the GUI of the user device with the dashboard interface component.

10. A computer program product for determining and locating network component errors in a distributed network, the computer program product comprising a non-transitory computer-readable medium comprising code causing an apparatus to:
collect, from at least one source component, exception data at a pre-defined interval;
group the exception data into at least one bucket based on the at least one source component, the pre-defined interval, and an exception type;
determine, based on the at least one bucket and by an artificial intelligence (AI) pattern module, an average exception count for the at least one bucket over the pre-defined interval;
collect historical exception data associated with the at least one bucket;
compare, by the AI pattern module, the historical exception data associated with the at least one bucket and the average exception count for the at least one bucket; and
determine, based on the comparison, an outlier exception pattern for the at least one bucket for the pre-defined interval.

11. The computer program product of claim 10, wherein the exception type is based on at least one of a source component flow, a source component sub-flow, a data center identifier, a server identifier, or an exception identifier.

12. The computer program product of claim 10, wherein the computer program product comprising the non-transitory computer-readable medium comprising code further causes the apparatus to:
collect metric data associated with the at least one source component;
extract, from the metric data, the exception data associated with the at least one source component;
generate an exception count for the exception data for the at least one source component and based on the exception type; and
generate the at least one bucket based on the exception count, the at least one source component, the pre-defined interval, and the exception type.

13. The computer program product of claim 10, wherein the AI pattern module comprises at least one of a z-score algorithm, an interquartile regression pattern, a quartile regression algorithm, or a standard deviation algorithm.

14. The computer program product of claim 10, wherein the exception type comprises at least one of a checked exception, an error exception, a runtime exception, a logical exception, an argument exception, a null reference exception, or a compilation exception.

15. The computer program product of claim 10, wherein the computer program product comprising the non-transitory computer-readable medium comprising code further causes the apparatus to:
determine, based on the pre-defined interval, a historical exception for the pre-defined interval;
compare the outlier exception pattern and the historical exception pattern for the pre-defined interval; and
determine, based on the comparison of the outlier exception pattern and the historical exception pattern, an outlier comparison score for the pre-defined interval, wherein the outlier comparison score indicates at least one of a sharp increase pattern or a consistent pattern.

16. A computer implemented method for determining and locating network component errors in a distributed network, the computer implemented method comprising:
collecting, from at least one source component, exception data at a pre-defined interval;
grouping the exception data into at least one bucket based on the at least one source component, the pre-defined interval, and an exception type;
determining, based on the at least one bucket and by an artificial intelligence (AI) pattern module, an average exception count for the at least one bucket over the pre-defined interval;
collecting historical exception data associated with the at least one bucket;
comparing, by the AI pattern module, the historical exception data associated with the at least one bucket and the average exception count for the at least one bucket; and
determining, based on the comparison, an outlier exception pattern for the at least one bucket for the pre-defined interval.

17. The computer implemented method of claim 16, wherein the exception type is based on at least one of a source component flow, a source component sub-flow, a data center identifier, a server identifier, or an exception identifier.

18. The computer implemented method of claim 16, further comprising:
collecting metric data associated with the at least one source component;
extracting, from the metric data, the exception data associated with the at least one source component;
generating an exception count for the exception data for the at least one source component and based on the exception type; and
generating the at least one bucket based on the exception count, the at least one source component, the pre-defined interval, and the exception type.

19. The computer implemented method of claim 16, wherein the AI pattern module comprises at least one of a z-score algorithm, an interquartile regression pattern, a quartile regression algorithm, or a standard deviation algorithm.

20. The computer implemented method of claim 16, wherein the exception type comprises at least one of a checked exception, an error exception, a runtime exception, a logical exception, an argument exception, a null reference exception, or a compilation exception.
